(19) United States
(12) Patent Application Publication
(10) Pub. No.: US 2026/0212200 A1
(43) Pub. Date: Jul. 23, 2026

(54) DYNAMIC WEIGHT ADJUSTMENT FOR MOTION CONTROL VIA MULTI-OBJECTIVE REINFORCEMENT LEARNING

(71) Applicant: DISNEY ENTERPRISES, INC., Burbank, CA (US)

(72) Inventors: Moritz Niklaus BÄCHER, Zürich (CH); Lars Espen KNOOP, Birmensdorf (CH); Ruben Jelle GRANDIA, Zürich (CH); Agon SERIFI, Zürich (CH); Lucas Nunes ALEGRE, Porto Alegre (BR); David Benjamin CAO, Winterthur (CH)

(21) Appl. No.: 19/456,638

(22) Filed: Jan. 22, 2026

Related U.S. Application Data
(60) Provisional application No. 63/748,403, filed on Jan. 22, 2025.

(51) Int. Cl. G06N 3/092; G06N 3/0475

(52) U.S. Cl. CPC G06N 3/092; G06N 3/0475

(57) ABSTRACT

One embodiment of the present invention sets forth a technique for controlling motion in an articulated object. The technique includes generating, via execution of a machine learning model based on a first state of the articulated object at a first time step, a first plurality of weights for a plurality of rewards, and determining (i) one or more actions at the first time step based on the first plurality of weights and (ii) a second state of the articulated object at a second time step based on the first state and the action(s). The technique also includes generating, via execution of the machine learning model based on the second state, a second plurality of weights for the plurality of rewards, and determining one or more additional actions based on the second plurality of weights. The technique further includes generating the motion based on the action(s) and additional action(s).

### CROSS-REFERENCE TO RELATED APPLICATIONS

This application claims the benefit of the U.S. Provisional Application titled “ADAPTIVE CHARACTER CONTROL VIA MULTI-OBJECTIVE REINFORCEMENT LEARNING,” filed on Jan. 22, 2025, and having Ser. No. 63/748,403. The subject matter of this application is hereby incorporated herein by reference in its entirety.

### BACKGROUND

### Field of the Various Embodiments

Embodiments of the present disclosure relate generally to motion tracking and reinforcement learning and, more specifically, to dynamic weight adjustment for motion control via multi-objective reinforcement learning.

### Description of the Related Art

Physics-based character control is a technique for generating motion in physical and/or virtual characters in a physically realistic and robust manner. To achieve this type of motion, a controller computes actions (e.g., joint torques, target positions, actuator commands, etc.) that cause a character to move in a desired manner while respecting physics constraints such as (but not limited to) gravity, momentum, friction, and/or contact forces. The actions are used to update joints of the character and produce physically plausible motion in a robot, game, animation, simulation, and/or another application involving the character.

Existing approaches for performing physics-based character control include the use of reinforcement learning (RL) to train a control policy to output actions that maximize a reward function. The reward function can include one or more objectives related to the accuracy with which a reference motion is tracked. When multiple objectives are included in the reward function, a set of weights is used to control the relative priorities and/or effects of the objectives on the outputted actions.

However, these approaches have traditionally used reward functions with fixed weights for individual tasks and/or stages within a task. When the weights are changed to adapt a policy to a new type of motion or environment, time- and resource intensive retraining of the policy is performed. Further, a set of weights that performs well with a certain type of motion (e.g., dancing) or environment (e.g., a character in a simulation) may produce suboptimal results with a different type of motion (e.g., walking) or environment (e.g., a robot in the real world). Because each set of weights is typically determined via manual tuning and/or input from an expert, it can be difficult and/or intractable to identify an optimal set of weights for each type of motion and/or environment.

As the foregoing illustrates, what is needed in the art are more effective techniques for perform physics-based character control.

### SUMMARY

One embodiment of the present invention sets forth a technique for controlling motion in an articulated object. The technique includes generating, via execution of a machine learning model based on a first state of the articulated object at a first time step, a first plurality of weights for a plurality of rewards, and determining (i) one or more actions at the first time step based on the first plurality of weights and (ii) a second state of the articulated object at a second time step based on the first state and the action(s). The technique also includes generating, via execution of the machine learning model based on the second state, a second plurality of weights for the plurality of rewards, and determining one or more additional actions based on the second plurality of weights. The technique further includes generating the motion based on the action(s) and additional action(s).

One technical advantage of the disclosed techniques relative to the prior art is the ability to specify, to a reinforcement learning policy that is used to control and/or track motion in the articulated object, different sets of weights representing different prioritizations and/or tradeoffs among multiple objectives. Consequently, the disclosed techniques can be used to dynamically change the behavior of the policy without performing time- and resource-intensive retraining. Another technical advantage of the disclosed techniques is the ability to dynamically adjust the weights in a way that optimizes for realistic and/or accurate motion in the articulated object. The disclosed techniques thus can be used to generate more complex motions and/or adapt motions to new environments more efficiently than existing approaches that involve manual selection and/or tuning of weights for each type of motion and/or environment. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of various embodiments.

FIG. 2 is a more detailed illustration of the motion control module of FIG. 1, according to various embodiments.

FIG. 3 illustrates how the training engine of FIG. 2 trains a machine learning model to perform motion control using multi-objective reinforcement learning, according to various embodiments.

FIG. 4 is a flow diagram of method steps for controlling the motion of an articulated object, according to various embodiments.

FIG. 5 is a more detailed illustration of the motion adaptation module of FIG. 1, according to various embodiments.

FIG. 6 illustrates how the training engine of FIG. 5 trains a machine learning model to dynamically adjust weights for motion control via multi-objective reinforcement learning, according to various embodiments.

FIG. 7 is a flow diagram of method steps for dynamically adjusting weights used to control the motion of an articulated object, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

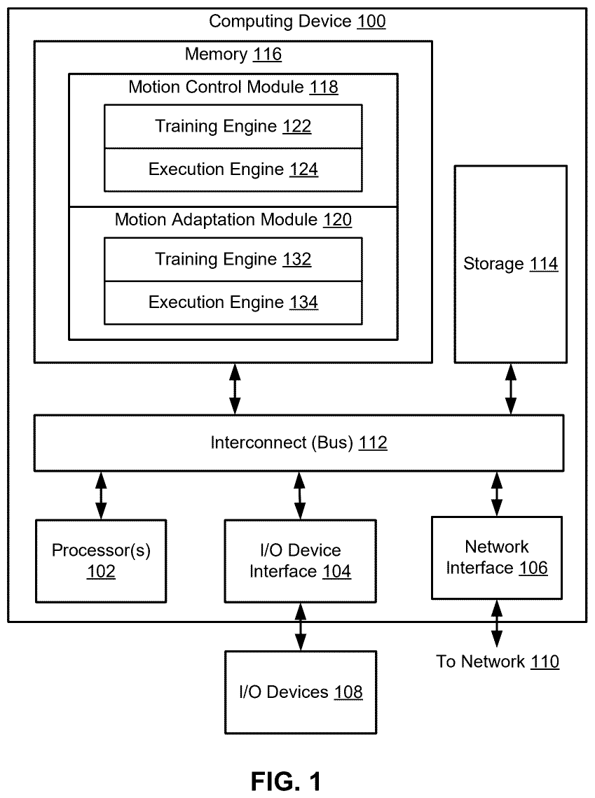

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a motion control module 118 and a motion adaptation module 120 that reside in a memory 116. Within memory 116, motion control module 118 includes a training engine 122 and an execution engine 124, and motion adaptation module 120 separately includes a training engine 132 and an execution engine 134.

It is noted that the computing device described herein is illustrative and that any other technically feasible configurations fall within the scope of the present disclosure. For example, multiple instances of motion control module 118, motion adaptation module 120, training engine 122, execution engine 124, training engine 132, and/or execution engine 124 may execute on a set of nodes in a distributed system to implement the functionality of computing device 100.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid state storage devices. Training engine 122 and execution engine 124 may be stored in storage 114 and loaded into memory 116 when executed.

Memory 116 includes a random access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including motion control module 118 and motion adaptation module 120.

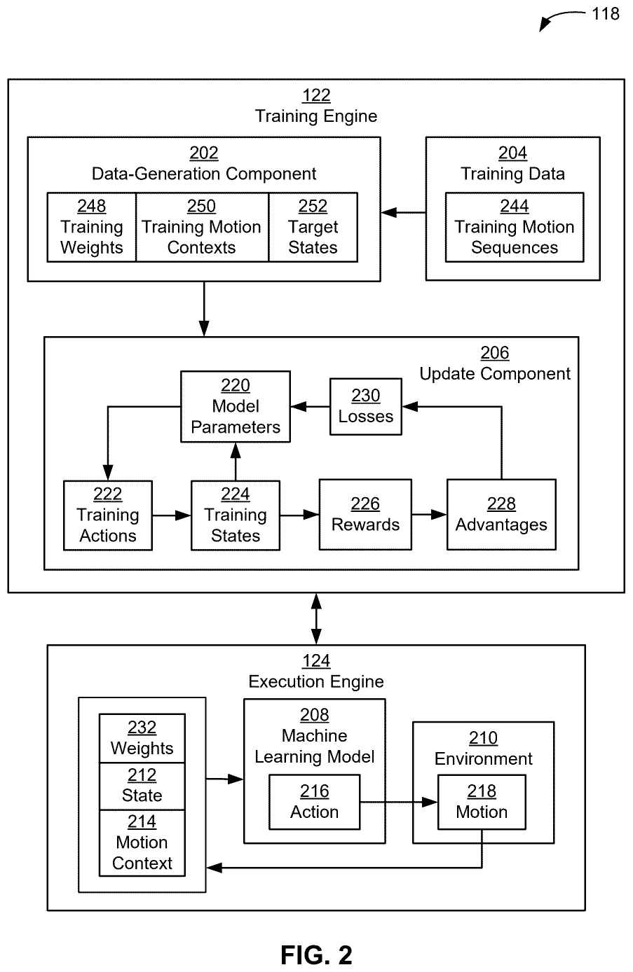

In one or more embodiments, motion control module 118 trains and executes a first machine learning model to control the motion of a legged robot (e.g., a humanoid robot or other bipedal robot, a quadruped robot, or a robot with any other number of articulated limbs for movement), physics-based character, and/or another type of articulated object. More specifically, motion control module 118 trains the first machine learning model to track a reference motion using multiple rewards representing different, potentially conflicting objectives. The training of the first machine learning model is conditioned on different sets of weight values representing different tradeoffs and/or priorities among the rewards. After training of the first machine learning model is complete, the first machine learning model is capable of generating additional motions using different weights for different time steps. Motion control module 118 is described in further detail below with respect to FIGS. 2-4.

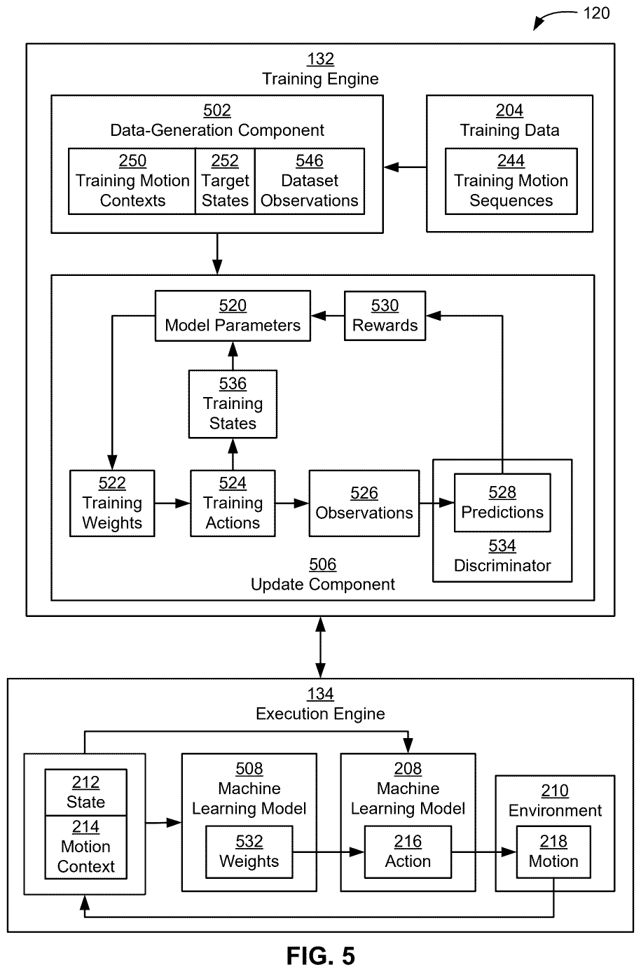

In one or more embodiments, motion adaptation module 120 trains and executes a second machine learning model to dynamically adjust weights used by the first machine learning model to perform motion control. The second machine learning model is trained to maximize a discriminator-based reward that encourages the second machine learning model to output weights that cause the first machine learning model to produce “simulated” motions that are indistinguishable from a set of reference motions. After training of the second machine learning model is complete, the second machine learning model can be used to generate time-varying weights that dynamically prioritize different objectives based on the current motion being performed and/or the current state of the articulated object. Motion adaptation module 120 is described in further detail below with respect to FIGS. 5-7.

### Adaptive Motion Control Via Multi-Objective Reinforcement Learning

FIG. 2 is a more detailed illustration of motion control module 118 of FIG. 1, according to various embodiments. As mentioned above, motion control module 118 is configured to train and execute a machine learning model 208 (e.g., a first machine learning model) to control the motion of a legged robot (e.g., a humanoid robot or other bipedal robot, a quadruped robot, or a robot with any other number of articulated limbs for movement), physics-based character, and/or another type of articulated object.

In one or more embodiments, machine learning model 208 corresponds to a reinforcement-learning (RL) policy that tracks a reference motion. This policy may be trained to output, for a given time step t in a motion 218 for the articulated object, an action 216 aₜ that maximizes a set of rewards 226 rₜ, given the current state 212 of the character sₜ and a context vector cₜ encoding information related to the reference motion.

Machine learning model 208 may include a neural network and/or another type of model architecture. For example, machine learning model 208 may include a multilayer perceptron (MLP) with exponential linear unit (ELU) activations.

State 212 includes information related to the configuration of the articulated object at a given time step. For example, state 212 may include joint positions, joint velocities, root position, root orientation, root velocity, joint positions, joint orientations, joint velocities, key point positions, contact states, and/or other properties of the articulated object at the time step.

Each action 216 generated by machine learning model 208 is used to generate and/or update motion 218 in a given environment 210. For example, each action 216 may include joint positions, joint orientations, joint torques, target joint velocities, actuator commands, key point positions, root velocities, and/or other types of output related to motion 218 in the articulated object. Action 216 may be used to actuate the degrees of freedom in the articulated object (e.g., via a proportional-derivative (PD) controller and/or actuator model) and produce a corresponding motion 218 in a real-world and/or simulated environment 210. Action 216 and/or motion 218 may also be used to generate an updated state 212 sₜ₊₁~p(⋅|sₜ,aₜ) for the next time step.

In some embodiments, motion context 214 cₜ includes a time-varying kinematic reference and/or a latent-space encoding of a motion window that captures past and future targets. For example, motion context 214 may be denoted by cₜ=(mₜ,zₜ), where mₜ is the current motion frame at time step t and zₜ is a latent representation of a motion window of frames Mₜ={m_{t-W}, . . . , m_{t+W}} that is centered at time step t and has size 2 W+1.

More specifically, mₜ=(hₜ,θₜ,vₜ,qₜ,\dot{q}ₜ,pₜ,\dot{p}ₜ), where hₜ represents the root height of the articulated object relative to the ground, θₜ is the orientation of the root in a six-dimensional (6D) representation, vₜ is a 6D-vector representing the linear and angular velocities of the root, qₜ and \dot{q}ₜ are angular positions and angular velocities, respectively, of the joints in the articulated object, pₜ is a nine-dimensional (9D) vector that encodes the poses of hands and feet relative to the root (3D position, 6D orientation), and \dot{p}ₜ encodes the corresponding linear velocities. To ensure that motion 218 is invariant to the global pose of the articulated object, mt may be normalized by expressing orientations and velocities with respect to the local heading frame of the root θₜ.

Additionally, the latent representation of the motion window may be generated by a variational autoencoder (VAE). The VAE may include an encoder e_{ψ}(zₜ|Mₜ) that maps the motion window to a distribution of latents zₜ∈ [symbol] ^{d}^{_{z}} and is modeled as a multivariate Gaussian distribution. A latent representation sampled from this distribution may be mapped back to the input motion window space by a decoder

$${M}_{t}^{′} = {d}_{ϕ} ( {z}_{t} ) .$$

The VAE may be trained using a reconstruction loss on the motion window:

$${ℒ}^{rec} ( {M}_{t} , {M}_{t}^{′} ) = \frac{1}{2 W + 1} {\sum }_{i = t - W}^{t + W} {l}^{rec} ( {m}_{i} , {m}_{i}^{′} ) , \qquad ( 1 )$$

and the weighted Kullback-Leibler (KL) divergence loss with a standard Gaussian distribution prior as the latent distribution. For individual frames, a loss may be computed on standard normalized quantities by first computing rotation matrices for orientations using the Gram-Schmidt process:

$${l}^{rec} ( {m}_{i} , {m}_{i}^{′} ) = {‖ {h}_{i} - {h}_{i}^{′} ‖}_{2}^{2} + {‖ R ( {θ}_{i} ) - R ( {θ}_{i}^{′} ) ‖}_{F}^{2} + {‖ {v}_{i} - {v}_{i}^{′} ‖}_{2}^{2} + {‖ {q}_{i} - {q}_{i}^{′} ‖}_{2}^{2} + {‖ {\dot{q}}_{i} - {\dot{q}}_{i}^{′} ‖}_{2}^{2} + {‖ {p}_{i} - {p}_{i}^{′} ‖}_{2}^{2} . \qquad ( 2 )$$

After training of the VAE is complete, the encoder may be used to encode motion windows for all motion frames in a given reference motion, resulting in a latent code zₜ per frame mt that captures local motion patterns around the frame. The start and end frames may be repeated at the beginning and end of the reference motion, respectively, to initialize complete motion windows.

Machine learning model 208 also generates action 216 based on a set of weights 232 for multiple rewards 226 related to motion 218. In particular, machine learning model 208 may be represented by π(aₜ|sₜ,cₜ,w), where w is a vector of weights associated with a vector of rewards 226 rₜ(sₜ,aₜ,sₜ₊₁)∈ [symbol] ^{m} and different elements in the vector of rewards represent distinct and potentially conflicting objectives. Rewards 226 may be accumulated over multiple time steps into a vector return J(π)= [symbol] _{π}[Σ_{t≥0}γ^{t}rₜ|s₀~d₀] to be maximized, where y∈[0,1) is a discount factor, π is the policy learned by machine learning model 208, and d₀ is an initial state distribution. Under this multi-objective reinforcement learning paradigm, multiple optimal solutions may exist along a Pareto front [symbol] . Each point on this Pareto front may be Pareto non-dominated, in which there is no other point J(π′) such that Jᵢ (π′)≥Jᵢ(π), ∀i and Jᵢ(π′)>Jᵢ(π) for at least one i∈{1, . . . , m} (e.g., no objective in the point can be improved without worsening at least one other objective).

In the context of motion control tasks, the Pareto front is convex and can be defined in terms of a linear dominance relation:

$$ℱ = \{ J ( π ) \vert ∃ w s . t . J ( π ) \cdot w \geq J ( {π}^{′} ) \cdot w , ∀ {π}^{′} \} , \qquad ( 3 )$$

where multiple weights 232 wᵢ in the reward weight vector w∈Δ^{m} form a convex combination satisfying the requirements

$${\sum }_{i = 1}^{m}$$

wᵢ=1 and wᵢ≥0. Each weight factor may be combined with the reward vector to produce a scalar reward rₜ=r(sₜ,aₜ,sₜ₊)·w. Due to the linearity of the expectation and sum operations, the expected discounted return to be maximized by an agent following the policy can be computed as

$$J ( π ) = {𝔼}_{π} [ {\sum }_{t \geq 0} {γ}^{t} {r}_{t} \cdot w ] = {𝔼}_{π} [ {\sum }_{t \geq 0} {γ}^{t} {r}_{t} ] \cdot w = J ( π ) \cdot w , \qquad ( 4 )$$

with the optimal solution denoted by J*=max_{π}J(π)·w. The corresponding policy π* is therefore optimal for any tradeoff w among the m objectives.

Training engine 122 trains machine learning model 208 using training data 204 that includes a set of training motion sequences 244. Each of training motion sequences 244 corresponds to a sequence of motion frames mₜ representing one or more reference motions in the articulated object. For example, a given training motion sequence may include walking, running, jogging, jumping, dancing, kicking, punching, strafing, crouching, waving, climbing, descending, gesturing, crouching, skipping, hopping, manipulating objects, pirouetting, and/or other types of reference motions. Each training motion sequence may be generated via a motion capture technique, animation technique, and/or another technique.

A data-generation component 202 in training engine 122 generates data that is used to train machine learning model 208. More specifically, data-generation component 202 generates different sets of training weights 248 w associated with rewards 226, training motion contexts 250 cₜ=(mₜ,zₜ) that include individual motion frames in training motion sequences 244 and corresponding encoded motion windows, and target states 252 ŝₜ to be attained at different time steps during tracking of reference motions in training motion sequences 244. For example, data-generation component 202 may sample different sets of training weights 248 from a multidimensional simplex Δ^{m} (e.g., by drawing from a Dirichlet distribution with parameter α=1) and/or generate one or more sets of training weights 248 using a search and/or optimization technique. Data-generation component 202 may also generate a different training motion context cₜ=(mₜ,zₜ) for each motion frame in training motion sequences 244. Data-generation component 202 may additionally generate each target state 252 using some or all attributes in a corresponding motion frame from a training motion sequence.

An update component 206 in training engine 122 trains machine learning model 208 using training weights 248, training motion contexts 250, and target states 252. In some embodiments, update component 206 selects a set of training weights and a training motion sequence for each training episode and environment 210 (e.g., real-world environment, simulated environment, etc.) in which machine learning model 208 performs motion tracking. During each time step of a given training episode, update component 206 inputs the selected training weights 248, a training motion context for that time step, and a training state at that time step (e.g., starting with a target state at the first time step of the training episode) into machine learning model 208. Update component 206 uses machine learning model 208 to generate training actions 222 based on the inputted training weights 248, training motion contexts 250, and states. Update component 206 updates training states 224 based on training actions 222 and previous training states 224 and computes rewards 226 using training states 224 and the corresponding target states 252. Update component 206 additionally computes a set of advantages 228 and losses 230 using rewards 226. Update component 206 then uses a training technique (e.g., gradient descent and backpropagation) to update model parameters 220 of machine learning model 208 in a way that reduces losses 230. Update component 206 repeats the process with additional training episodes and/or training motion sequences 244 until training of machine learning model 208 is complete.

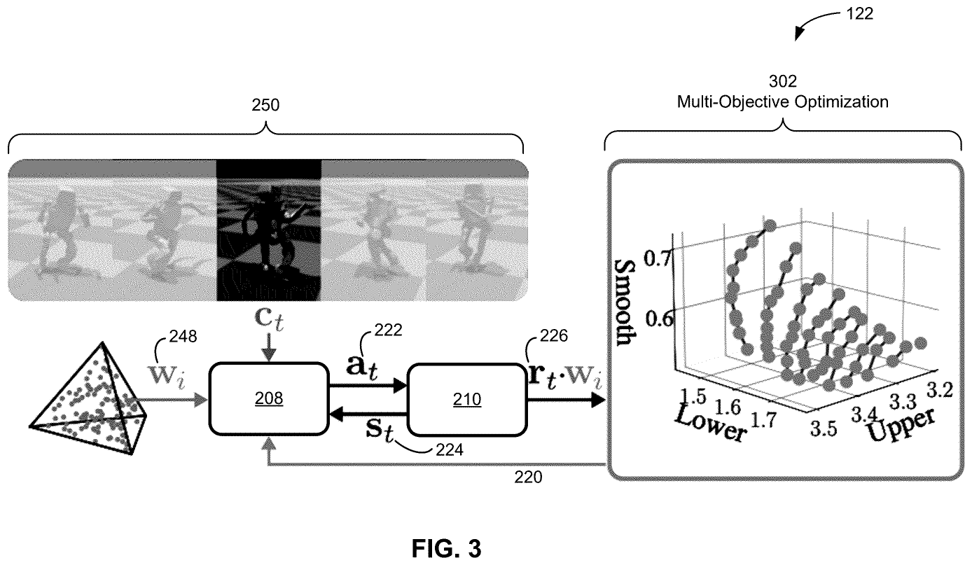

FIG. 3 illustrates how training engine 122 of FIG. 2 trains machine learning model 208 to perform motion control using multi-objective reinforcement learning, according to various embodiments. As shown in FIG. 3, training engine 122 samples training weights 248 from a multidimensional simplex and inputs the sampled training weights 248 into machine learning model 208 for each time step of a training episode. Training engine 122 also inputs training motion contexts 250 and training states 224 associated with individual time steps of the training episode into machine learning model 208. Given this input, machine learning model 208 generates training actions 222 for the same time steps. These training actions 222 are performed within environment 210 to produce updated training states 224 for subsequent time steps in the training episode.

Training actions 222 and training states 224 are also used to generate a set of rewards 226 for each time step. Each set of rewards 226 is combined with training weights 248 and used in a multi-objective optimization 302 that updates model parameters 220 of machine learning model 208.

In one or more embodiments, rewards 226 include the following representation:

$$r ( {s}_{t} , {a}_{t} , {s}_{t + 1} , {c}_{t} ) = {[ {r}_{t}^{up} , {r}_{t}^{lo} , {r}_{t}^{feet} , {r}_{t}^{rbs} , {r}_{t}^{root} , {r}_{t}^{vel} , {r}_{t}^{s m o o t h} ]}^{T} , \qquad ( 5 )$$

where:

$${r}^{u p} = {‖ {q}_{u p} - {\hat{q}}_{u p} ‖}_{2}^{2}$$

tracks the upper joint positions and height,

$${r}^{lo} = {‖ {q}_{lo} - {\hat{q}}_{lo} ‖}_{2}^{2}$$

tracks lower joint positions,

$${r}^{feet} = {‖ {q}_{f} - {\hat{q}}_{f} ‖}_{2}^{2}$$

tracks the positions of the ankle joints,

$${r}^{rbs} = \{ \begin{matrix}{‖ p - \hat{p} ‖}_{2}^{2} \\ {‖ \text{?} ( p ) - \text{?} ( \hat{p} ) ‖}_{2}^{2} \\ {‖ \dot{p} - \hat{\dot{p}} ‖}_{2}^{2}\end{matrix}$$

tracks the positions and orientations of end-effectors,

$${r}^{root} = {‖ \text{?} ( θ ) - \text{?} ( \hat{θ} ) ‖}_{2}^{2}$$

tracks the orientation of the root,

$${r}^{vel} = \{ \begin{matrix}{‖ {v}_{lin} - {\hat{v}}_{lin} ‖}_{2}^{2} \\ {‖ {v}_{ang} - {\hat{v}}_{ang} ‖}_{2}^{2}\end{matrix}$$

tracks the linear and angular velocities of the joints and root, and

$${r}^{s m o o t h} = \{ \begin{matrix}- {‖ τ ‖}_{2}^{2} \\ - {‖ {a}_{t} - {a}_{t - 2} ‖}_{2}^{2} \\ - {‖ {a}_{t} - 2 {a}_{t - 1} + {a}_{t - 2} ‖}_{2}^{2} \\ - {‖ \ddot{q} ‖}_{2}^{2}\end{matrix}$$

penalizes high action rates and torques to mitigate vibrations and smooth the resulting motion.

In some embodiments, r^{up}, r^{lo}, r^{feet}, r^{rbs}, r^{root}, and r^{vel} are tracking rewards that represent objectives related to the accuracy with which motions in training data 204 are tracked, while r^{smooth} is a smoothness reward that represents an objective related to smoothness in motions generated by machine learning model 208. Training weights 248 can be adjusted to adapt the tradeoff between tracking accuracy and smoothness in motion to different environments and/or types of motions. For example, training weights 248 that prioritize smoothness may reduce jitter in more dynamic motions such as dancing but may also reduce tracking accuracy.

Further, q_{up|lo|f} denote the DoFs for the upper body, lower body, and feet, respectively; [symbol] : [symbol] ⁿ→SO(3)⊂ [symbol] ^{3×3} represents the transformation that maps quaternions or 6D rotation representations to their corresponding rotation matrix in SO(3); v_{lin|ang} respectively denote the linear and angular velocity of the root; T corresponds to torque; and \ddot{q} indicates joint accelerations. Each reward may be computed using one or more attributes from a state associated with a given time step and one or more attributes denoted by ( [symbol] ) from a corresponding target state.

When a reward includes multiple terms (e.g., r^{rbs}, r^{vel}, r^{smooth}), these terms may be aggregated and/or otherwise combined into a single value that is then combined with a corresponding weight. Because these rewards 226 may vary significantly in magnitude, a prior scaling may be applied to each reward. This prior scaling may include different values for different types of articulated objects. Further, one or more rewards 226 may include a constant survival bonus c^{alive} for not reaching a terminal state (e.g., falling to the ground) to prevent the policy from terminating as quickly as possible to avoid a negative accumulation of reward.

Returning to the discussion of FIG. 2, in some embodiments, training engine 122 uses a multi-objective extension of the Proximal Policy Optimization (PPO) algorithm to train machine learning model 208. This multi-objective extension trains a critic to learn a vector-valued function conditioned on a given set of training weights 248 w:

$${V}^{π} ( s , c , w ) = {𝔼}_{π} [ {\sum }_{t \geq 0} {γ}^{t} {r}_{t} \vert {s}_{0} = s , {c}_{0} = c ] . \qquad ( 6 )$$

Losses 230 may be computed using a PPO clipped loss function that is constructed using a multi-objective policy gradient:

$${∇}_{π} [ J ( π ) \cdot w ] = {𝔼}_{{d}^{π}} [ {\sum }_{t \geq 0} ( {A}^{π} ( {s}_{t} , {c}_{t} , {a}_{t} ) \cdot w ) {∇}_{π} log π ( {a}_{t} \vert {s}_{t} , {c}_{t} , w ) ] \qquad ( 7 )$$

that relies on a vector-valued advantage function A^{π}(sₜ,cₜ,aₜ). Here, d^{π} represents the discounted stationary distribution of states induced by π and the environment dynamics sₜ₊₁,cₜ₊₁~p(⋅|sₜ,cₜ,aₜ). This training of machine learning model 208 using different sets of training weights 248 may allow the policy to generate behaviors corresponding to Pareto non-dominated tradeoffs among multiple objectives.

In some embodiments, the advantage function is scalarized using training weights 248 A^{π}·w, and the result may be normalized using the mean and standard deviation over each mini-batch. Generalized advantage estimation (GAE) may be used to estimate the advantage function.

After training of machine learning model 208 is complete, execution engine 124 uses the trained machine learning model 208 to generate and/or track additional motions according to weights 232. For example, execution engine 124 may begin generating a given motion 218 by inputting a set of weights 232, an initial state 212 associated with a starting time step in that motion 218, and motion context 214 associated with the initial state 212 into machine learning model 208. Execution engine 124 may use machine learning model 208 to generate an action 216 for the starting time step. Execution engine 124 may also convert action 216 into a corresponding motion 218 within environment 210 and/or a new state 212 for the next time step. Execution engine 124 may repeat the process for subsequent time steps in the same motion 218 using the new state 212, a corresponding motion context 214, and the same set of weights 232 or a different set of weights 232 until the generated motion 218 is complete and/or another condition is met.

In one or more embodiments, weights 232 are selected and/or tuned by a user to adapt motion 218 to different objectives and/or priorities. For example, the user may increase the weight for smoothness in rewards 226 at the expense of tracking performance to reduce jitter and/or a sim-to-real gap in performing a dancing motion 218. In another example, the user may iteratively adjust weights 232 to produce a complex motion 218 in a real-world robot without retraining machine learning model 208. Weights 232 may also, or instead, be selected and/or tuned by a different machine learning model, as described in further detail below with respect to FIGS. 5-7.

Execution engine 124 may also use the generated motion 218 in various applications. For example, execution engine 124 may simulate the articulated object performing motion 218 in an animation, game, virtual reality (VR), augmented reality (AR), and/or mixed reality (MR) environment 210. This content can depict virtual worlds that can be experienced by any number of users synchronously and persistently, while providing continuity of data such as (but not limited to) personal identity, user history, entitlements, possession, and/or payments. It is noted that this content can include a hybrid of traditional audiovisual content and fully immersive VR, AR, and/or MR experiences, such as interactive video. In another example, execution engine 124 may generate commands that cause a robot corresponding to the articulated object to perform motion 218 in a real-world environment 210.

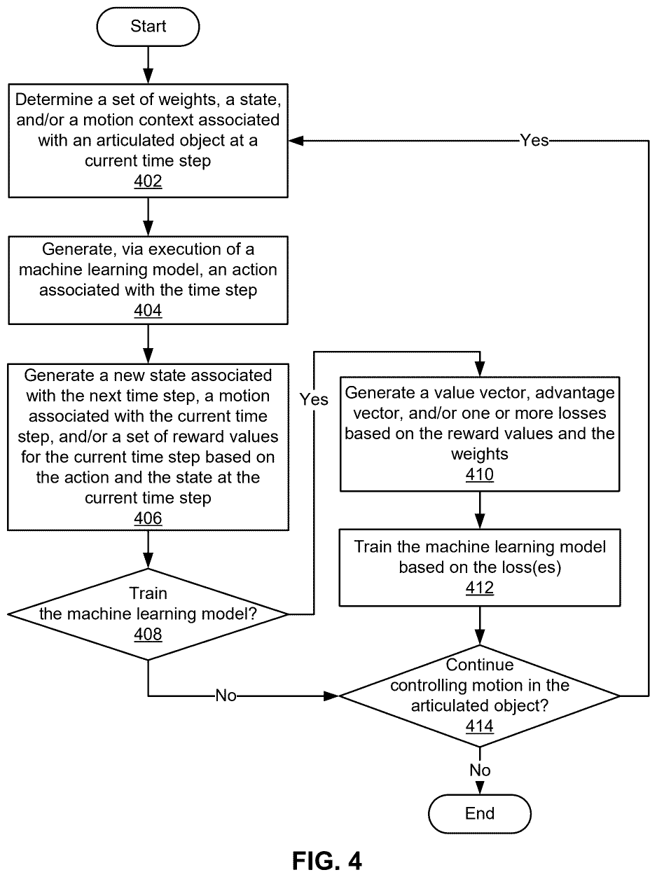

FIG. 4 is a flow diagram of method steps for controlling the motion of an articulated object, according to various embodiments. Although the method steps are described in conjunction with the systems of FIGS. 1-3, persons skilled in the art will understand that any system configured to perform the method steps in any order falls within the scope of the present disclosure.

As shown, in step 402, training engine 122 and/or execution engine 124 determine a set of weights, a state, and/or a motion context associated with an articulated object at a current time step. For example, training engine 122 and/or execution engine 124 may initialize the state and/or motion context using one or more motion frames from a reference motion. Training engine 122 and/or execution engine 124 may also randomize the weights and/or receive the weights from a user, machine learning model, optimization technique, and/or another source.

In step 404, training engine 122 and/or execution engine 124 generate, via execution of a machine learning model, an action associated with the time step. For example, training engine 122 and/or execution engine 124 may input the weights, state, and/or motion context from step 402 into an MLP and/or another type of machine learning model. Training engine 122 and/or execution engine 124 may also execute the machine learning model to generate an action for the same time step.

In step 406, training engine 122 and/or execution engine 124 generate a new state associated with the next time step, a motion associated with the current time step, and/or a set of reward values for the current time step based on the action and the state at the current time step. For example, training engine 122 and/or execution engine 124 may use a PD controller, actuator model, and/or another technique to generate a motion frame for the current time step from the action. Training engine 122 and/or execution engine 124 may also, or instead, use the action and state at the current time step to determine a new state at the next time step. Training engine 122 and/or execution engine 124 may also, or instead, compute the reward values by characterizing the smoothness of the motion and/or comparing attributes of the current and/or new state to corresponding attributes of one or more target states from a reference motion.

In step 408, training engine 122 and/or execution engine 124 determine whether or not to train the machine learning model. For example, training engine 122 and/or execution engine 124 may determine that the machine learning model is to be trained based on user input, a mode and/or context in which the machine learning model is used, after a batch of trajectories and corresponding rewards have been collected, and/or based on other criteria.

If training engine 122 and/or execution engine 124 determine that the machine learning model is to be trained, training engine 122 performs step 410, in which training engine 122 generates a value vector, advantage vector, and/or one or more losses based on the reward values and the weights. For example, training engine 122 may use a critic model to generate the value vector, compute the advantage vector using the value vector and GAE, and scalarize the advantage vector using the weights. Training engine 122 may also compute a PPO clipped loss and/or another type of loss using the scalarized advantage.

In step 412, training engine 122 trains the machine learning model based on the loss(es). For example, training engine 122 and/or execution engine 124 may update model parameters of the machine learning model in a way that reduces the losses.

If training engine 122 and/or execution engine 124 determine in step 408 that the machine learning model is not to be trained, steps 410 and 412 are skipped. Instead, the generated motion may be outputted in a real-world, simulated, and/or another type of environment.

In step 414, training engine 122 and/or execution engine 124 determine whether to continue controlling motion in the articulated object. For example, training engine 122 and/or execution engine 124 may determine that motion in the articulated object should continue to be controlled if additional time steps remain in the reference motion; a predefined number of training episodes, batches, and/or epochs has not been performed; and/or another termination condition has not been met. While training engine 122 and/or execution engine 124 determine that motion in the articulated object should continue to be controlled, training engine 122 and/or execution engine 124 repeat steps 402-414 to generate additional actions and motions associated with the articulated object and/or train the machine learning model using the corresponding rewards. Training engine 122 and/or execution engine 124 may continue performing steps 402-414 until training engine 122 and/or execution engine 124 determine in step 414 that control of motion in the articulated object is to be discontinued.

### Dynamic Weight Adjustment for Motion Control Via Multi-Objective Reinforcement Learning

FIG. 5 is a more detailed illustration of motion adaptation module 120 of FIG. 1, according to various embodiments. As discussed above, motion adaptation module 120 is configured to train and execute a machine learning model 508 (e.g., a second machine learning model) to dynamically adjust weights used by machine learning model 208 to control the motion of a humanoid robot, bipedal robot, virtual character, and/or another type of articulated object.

In one or more embodiments, machine learning model 508 corresponds to a high-level policy that generates weights 532 based on state 212 and motion context 214 at a given time step in motion 218 for the articulated object. For example, machine learning model 508 may be represented by π̅(wₜ|sₜ,cₜ). Weights 532 generated by machine learning model 508 may prioritize different objectives based on the type of motion being performed, the current configuration of the articulated object, environment 210, the type of articulated object (e.g., humanoid robot, bipedal robot, human, animal, etc.), and/or other factors.

As with machine learning model 208, machine learning model 508 may include a neural network and/or another type of model architecture. For example, machine learning model 508 may include a multilayer perceptron (MLP) with exponential linear unit (ELU) activations. The final layer of the MLP may include a softmax activation function to ensure that weights 532 are outputted in the simplex wₜ∈Δ^{m}.

Each set of weights 532 generated by machine learning model 508 is inputted into machine learning model 208 along with state 212 and motion context 214. For example, weights 532, state 212, and motion context 214 for a given time step may be input into a trained machine learning model 208 with frozen parameters. Given these inputs, machine learning model 208 generates a corresponding action 216 that is converted into motion 218 in environment 210. Action 216 and/or motion 218 may also be used to generate an updated state 212 and motion context 214 for the next time step.

Training engine 132 trains machine learning model 508 using training data 204 that includes training motion sequences 244. As shown in FIG. 5, a data-generation component 502 in training engine 132 generates training motion contexts 250 and target states 252 from motion frames in training motion sequences 244. Data-generation component 502 also generates dataset observations 546 using attributes in the motion frames. For example, each set of dataset observations 546 may be represented by oₜ=(θₜ,vₜ,qₜ) and include root orientations, root velocities, and joint angular positions from a corresponding motion frame in training motion sequences 244.

An update component 506 in training engine 132 trains machine learning model 508 using training motion contexts 550, target states 252, and dataset observations 546. During each time step of a given training episode, update component 506 inputs a training motion context and a training state at that time step (e.g., starting with a target state at the first time step of the training episode) into machine learning model 508. Update component 506 uses machine learning model 508 to generate training weights 522 based on the inputted training motion contexts 250 and training states 536. Update component 506 inputs training weights 522 to machine learning model 208 and obtains corresponding training actions 524 as output of machine learning model 208. Update component 506 converts training actions 524 into corresponding motions and generates observations 526 from the motions.

Update component 506 also uses a discriminator 534 to evaluate observations 526. More specifically, discriminator 534 may be trained to distinguish between dataset observations 546 derived from training motion sequences 244 and observations 526 derived from training actions 524 and the corresponding motions. Predictions 528 outputted by discriminator 534 may indicate whether a given window of observations Oₜ={o_{t-V}, . . . , oₜ} corresponds to a reference motion from training motion sequences 244 or a simulated motion generated using machine learning model 208. Update component 506 computes one or more rewards 530 using predictions 528 and uses a training technique to update model parameters 520 of machine learning model 508 in a way that maximizes rewards 530. Update component 506 repeats the process with additional training episodes and/or training motion sequences 244 until training of machine learning model 508 is complete.

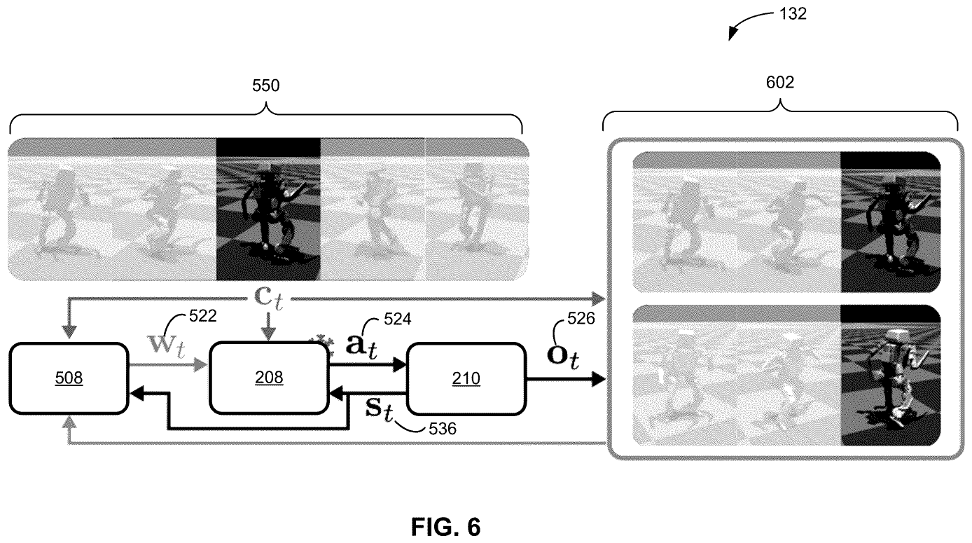

FIG. 6 illustrates how training engine 132 of FIG. 5 trains a machine learning model to dynamically adjust weights for motion control via multi-objective reinforcement learning, according to various embodiments. As shown in FIG. 6, training engine 132 inputs training motion contexts 550 and training states 536 for individual steps of a training episode into machine learning model 508. Based on this input, machine learning model 508 generates training weights 522 for the same time steps. These training weights 522 are further inputted into machine learning model 208, which generates training actions 524 that are performed within environment 210 to produce observations 526 for the same time steps. These observations 526 are used in an optimization 602 that involves discriminator 534 and is used to update model parameters 520 of machine learning model 208.

In one or more embodiments, discriminator 534 is represented by D(Oₜ|zₜ) and attempts to distinguish between dataset transitions Ôₜ~d^{M}(Ôₜ,zₜ) derived from reference motions and transitions Oₜ~d^{π}(Oₜ,z) derived from observations 526, where d^{M}(Ôₜ,zₜ) and d^{π}(Oₜ,zₜ) are state transition distributions of the reference motions and observations 526, respectively. Discriminator 534 may be trained using the following loss function:

$${L}^{D} = - {E}_{{M}_{t} ∈ 𝒟} [ {L}^{M} + {L}^{π} + {c}^{g p} {L}^{g p} \vert {z}_{t} = e ( {M}_{t} ) ] \qquad ( 8 )$$

$$with terms$$

$${L}^{M} = {E}_{{d}^{M} ( {\hat{O}}_{t} , {z}_{t} )} log D ( {\hat{O}}_{t} \vert {z}_{t} )$$

$${L}^{π} = {E}_{{d}^{π} ( {O}_{t} , {z}_{t} )} log ( 1 - D ( {O}_{t} \vert {z}_{t} ) )$$

$${L}^{g p} = {E}_{{d}^{M} ( {\hat{O}}_{t} , {z}_{t} )} {‖ {∇}_{ϕ} D ( ϕ ) {\vert}_{ϕ = ( {\hat{O}}_{t} , {z}_{t} )} ‖}^{2} .$$

More specifically, L^{M} encourages discriminator 534 to output high scores for dataset transitions derived from reference motions, L^{π} encourages discriminator 534 to output low scores for transitions derived from observations 526, and L^{gp} is a gradient penalty that is scaled by coefficient c^{gp} and used to penalize nonzero gradients on samples from reference motions.

Rewards 530 for training machine learning model 508 may be computed using discriminator 534 output:

$${r}^{D} ( {O}_{t} , {z}_{t} ) = - log ( 1 - D ( {O}_{t} \vert {z}_{t} ) ) \qquad ( 9 )$$

These rewards 530 encourage machine learning model 508 to select training weights 522 that result in motion that cannot be distinguished from reference motion, given the corresponding training motion contexts 250. Maximizing rewards 530 allows machine learning model 508 to select training weights 522 that lead to more realistic motion transitions for a given training state and training motion context.

Returning to the discussion of FIG. 5, after training of machine learning model 508 is complete, execution engine 134 uses the trained machine learning model 508 to dynamically adapt motion 218 to motion context 214 and state 212 during generation of a corresponding motion 218 by machine learning model 208. For example, execution engine 134 may input an initial state 212 and motion context 214 associated with a starting time step of motion 218 into machine learning model 508. Execution engine 134 may use machine learning model 508 to generate weights 532 for the starting time step. Execution engine 134 may also use machine learning model 208 to generate a corresponding action 216 for the same time step based on the generated weights 532, state 212, and motion context 214. Execution engine 134 may further convert action 216 into a corresponding motion 218 within environment 210 and/or a new state 212 for the next time step. Execution engine 134 may repeat the process using the new state 212 and a corresponding motion context 214 to generate new weights 532 for each subsequent time step until the generated motion 218 is complete and/or another condition is met.

In some embodiments, execution engine 134 modifies weights 532 generated by machine learning model 508 prior to inputting weights 532 into machine learning model 208. For example, a user may specify changes to some or all weights 532 and/or prioritization of certain objectives during a given type of motion. Execution engine 134 may apply the changes and/or prioritization to weights 532 generated by machine learning model 508, thus allowing the user to further control the generation of motion 218.

Execution engine 134 may also use the generated motion 218 in various applications. For example, execution engine 134 may simulate the articulated object performing motion 218 in an animation, game, virtual reality (VR), augmented reality (AR), and/or mixed reality (MR) environment 210. This content can depict virtual worlds that can be experienced by any number of users synchronously and persistently, while providing continuity of data such as (but not limited to) personal identity, user history, entitlements, possession, and/or payments. It is noted that this content can include a hybrid of traditional audiovisual content and fully immersive VR, AR, and/or MR experiences, such as interactive video. In another example, execution engine 134 may generate commands that cause a robot corresponding to the articulated object to perform motion 218 in a real-world environment 210.

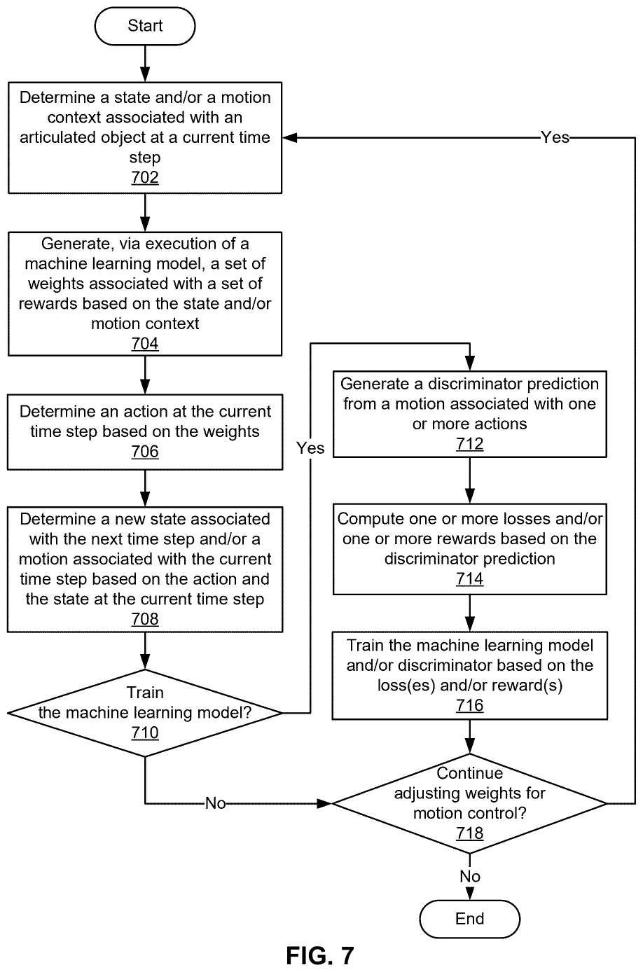

FIG. 7 is a flow diagram of method steps for dynamically adjusting weights used to control the motion of an articulated object, according to various embodiments. Although the method steps are described in conjunction with the systems of FIGS. 1 and 5-6, persons skilled in the art will understand that any system configured to perform the method steps in any order falls within the scope of the present disclosure.

As shown, in step 702, training engine 132 and/or execution engine 134 determine a state and/or a motion context associated with an articulated object at a current time step. For example, training engine 132 and/or execution engine 134 may generate the state and/or motion context using one or more motion frames from a reference motion.

In step 704, training engine 132 and/or execution engine 134 generate, via execution of a machine learning model, a set of weights associated with a set of rewards based on the state and/or motion context. For example, training engine 132 and/or execution engine 134 may input the state and/or motion context from step 702 into an MLP and/or another type of machine learning model. Training engine 132 and/or execution engine 134 may also execute the machine learning model to generate the set of weights for the same time step.

In step 706, training engine 132 and/or execution engine 134 determine an action at the current time step based on the weights. For example, training engine 132 and/or execution engine 134 may use another machine learning model to generate the action based on the weights, state, and/or motion context.

In step 708, training engine 132 and/or execution engine 134 determine a new state associated with the next time step and/or a motion associated with the current time step based on the action and the state at the current time step. For example, training engine 132 and/or execution engine 134 may use a PD controller, actuator model, and/or another technique to generate a motion frame for the current time step from the action. Training engine 132 and/or execution engine 134 may also, or instead, use the action and state at the current time step to determine a new state at the next time step.

In step 710, training engine 132 and/or execution engine 134 determine whether or not to train the machine learning model. For example, training engine 132 and/or execution engine 134 may determine that the machine learning model is to be trained based on user input, a mode and/or context in which the machine learning model is used, after a batch of trajectories and corresponding observations have been collected, and/or based on other criteria.

If training engine 132 and/or execution engine 134 determine that the machine learning model is to be trained, training engine 132 performs step 712, in which training engine 132 generates a discriminator prediction from a motion associated with one or more actions. For example, training engine 132 may input a window of observations derived from the motion and/or a latent representation of a corresponding motion window into a discriminator model. Given this input, the discriminator model may output a prediction indicating whether the observations correspond to a reference motion or a simulated motion generated using the machine learning model.

In step 714, training engine 132 computes one or more losses and/or one or more rewards based on the discriminator prediction. For example, training engine 132 may compute losses that encourage the discriminator to distinguish between reference motions and simulated motions. In another example, training engine 132 may compute a reward for the machine learning model based on the ability of the discriminator model to accurately identify simulated motions generated using the machine learning model.

In step 716, training engine 132 trains the machine learning model and/or discriminator based on the loss(es) and/or reward(s). For example, training engine 132 may update model parameters of the machine learning model in a way that maximizes the reward(s) and/or update parameters of the discriminator in a way that reduces the loss(es).

If training engine 132 and/or execution engine 134 determine in step 710 that the machine learning model is not to be trained, steps 712, 714, and 716 are skipped. Instead, the generated motion may be outputted in a real-world, simulated, and/or another type of environment.

In step 718, training engine 132 and/or execution engine 134 determine whether to continue adjusting weights for motion control in the articulated object. For example, training engine 132 and/or execution engine 134 may determine that weights should continue to be adjusted if additional time steps remain in the reference motion; a predefined number of training episodes, batches, and/or epochs has not been performed; and/or another termination condition has not been met. While training engine 132 and/or execution engine 134 determine that weights should continue to be adjusted, training engine 132 and/or execution engine 134 repeat steps 702-718 to generate additional weights and motions associated with the articulated object and/or train the machine learning model using the corresponding discriminator predictions. Training engine 132 and/or execution engine 134 may continue repeating steps 702-718 until training engine 132 and/or execution engine 134 determine in step 718 that adjustment of weights for motion control is to be discontinued.

In sum, the disclosed techniques perform adaptive motion control via multi-objective reinforcement learning, in which machine learning models corresponding to reinforcement learning policies generate and/or track motions in an articulated object based on a weighted combination of multiple rewards representing different, potentially conflicting objectives. A first machine learning model is trained to track a reference motion using multiple rewards representing different, potentially conflicting objectives. The training of the first machine learning model is conditioned on different sets of weight values representing different tradeoffs and/or priorities among the rewards. After training of the first machine learning model is complete, the first machine learning model is capable of generating additional motions using different weights for different time steps.

A second machine learning model is trained to dynamically adjust weights used by the first machine learning model to perform motion control. The second machine learning model is trained to maximize a discriminator-based reward that encourages the second machine learning model to output weights that cause the first machine learning model to produce “simulated” motions that are indistinguishable from a set of reference motions. After training of the second machine learning model is complete, the second machine learning model can be used to generate time-varying weights that dynamically prioritize different objectives based on the current motion being performed and/or the current state of the articulated object.

One technical advantage of the disclosed techniques relative to the prior art is the ability to specify, to a reinforcement learning policy that is used to control and/or track motion in the articulated object, different sets of weights representing different prioritizations and/or tradeoffs among multiple objectives. Consequently, the disclosed techniques can be used to dynamically change the behavior of the policy without performing time- and resource-intensive retraining. Another technical advantage of the disclosed techniques is the ability to dynamically adjust the weights in a way that optimizes for realistic and/or accurate motion in the articulated object. The disclosed techniques can thus be used to generate more complex motions and/or adapt motions to new environments more efficiently than existing approaches that involve manual selection and/or tuning of weights for each type of motion and/or environment. These technical advantages provide one or more technological improvements over prior art approaches.
1. In some embodiments, a computer-implemented method for controlling motion in an articulated object comprises generating, via execution of a machine learning model, one or more actions based on (i) a first state of the articulated object at a first time and (ii) a first plurality of weights associated with a plurality of rewards; generating, via execution of the machine learning model, one or more additional actions based on (i) a second state of the articulated object at a second time and (ii) a second plurality of weights associated with the plurality of rewards; and generating the motion based on the one or more actions and the one or more additional actions.
2. The computer-implemented method of clause 1, further comprising computing a plurality of reward values for the plurality of rewards based on at least one of the first state, the one or more actions, or the second state; computing one or more losses based on the plurality of reward values and the first plurality of weights; and training the machine learning model based on the one or more losses.
3. The computer-implemented method of any of clauses 1-2, wherein computing the one or more losses comprises generating (i) a value vector and (ii) an advantage vector based on the plurality of reward values and the first plurality of weights; and computing the one or more losses based on a scalarization of the advantage vector using the first plurality of weights.
4. The computer-implemented method of any of clauses 1-3, wherein the first time corresponds to a first training episode associated with the machine learning model and the second time corresponds to a second training episode associated with the machine learning model.
5. The computer-implemented method of any of clauses 1-4, further comprising determining the second state of the articulated object at the second time based on the first state and the one or more actions.
6. The computer-implemented method of any of clauses 1-5, further comprising generating, via execution of an additional machine learning model during a first time step corresponding to the first time, the first plurality of weights based on the first state; and generating, via execution of the additional machine learning model during a second time step corresponding to the second time, the second plurality of weights based on the second state.
7. The computer-implemented method of any of clauses 1-6, wherein the machine learning model further generates the one or more actions based on (i) a motion reference at the first time and (ii) a latent representation of a motion window that is centered at the first time.
8. The computer-implemented method of any of clauses 1-7, wherein the motion is generated in a real-world environment or a simulated environment.
9. The computer-implemented method of any of clauses 1-8, wherein the plurality of rewards comprises at least one of a tracking reward or a smoothness reward.
10. The computer-implemented method of any of clauses 1-9, wherein the articulated object comprises at least one of a legged robot or a physics-based character.
11. In some embodiments, one or more non-transitory computer-readable media store instructions that, when executed by one or more processors, cause the one or more processors to perform the steps of generating, via execution of a machine learning model, one or more actions based on (i) a first state of an articulated object at a first time and (ii) a first plurality of weights associated with a plurality of rewards; generating, via execution of the machine learning model, one or more additional actions based on (i) a second state of the articulated object at a second time and (ii) a second plurality of weights associated with the plurality of rewards; and generating a motion based on the one or more actions and the one or more additional actions.
12. The one or more non-transitory computer-readable media of clause 11, wherein the instructions further cause the one or more processors to perform the steps of computing a plurality of reward values for the plurality of rewards based on the first state, the one or more actions, and the second state; computing one or more losses based on the plurality of reward values and the first plurality of weights; and training the machine learning model based on the one or more losses.
13. The one or more non-transitory computer-readable media of any of clauses 11-12, wherein computing the one or more losses comprises generating, via execution of an additional machine learning model, (i) a value vector and (ii) an advantage vector based on the plurality of reward values and the first plurality of weights; and computing the one or more losses based on a scalarization of the advantage vector using the first plurality of weights.
14. The one or more non-transitory computer-readable media of any of clauses 11-13, wherein the instructions further cause the one or more processors to perform the step of training the additional machine learning model based on the one or more losses.
15. The one or more non-transitory computer-readable media of any of clauses 11-14, wherein the plurality of reward values is further computed based on a target motion associated with the first time.
16. The one or more non-transitory computer-readable media of any of clauses 11-15, wherein the instructions further cause the one or more processors to perform the steps of generating, via execution of an additional machine learning model during a first time step corresponding to the first time, the first plurality of weights based on the first state and a latent representation of a motion window that is centered at the first time; determining the second state of the articulated object at the second time based on the first state and the one or more actions; and generating, via execution of the additional machine learning model during a second time step corresponding to the second time, the second plurality of weights based on the second state.
17. The one or more non-transitory computer-readable media of any of clauses 11-16, wherein the instructions further cause the one or more processors to perform the step of receiving the first plurality of weights and the second plurality of weights from a user.
18. The one or more non-transitory computer-readable media of any of clauses 11-17, wherein the machine learning model comprises a multi-layer perceptron.
19. The one or more non-transitory computer-readable media of any of clauses 11-18, wherein the plurality of rewards is associated with at least one of a joint position, an end effector pose, a root orientation, a linear velocity, an angular velocity, or a smoothness.
20. In some embodiments, a system comprises one or more memories that store instructions, and one or more processors that are coupled to the one or more memories and, when executing the instructions, are configured to perform the steps of generating, via execution of a machine learning model, one or more actions at a first time based on (i) a first state of an articulated object at a first time step and (ii) a first plurality of weights associated with a plurality of rewards; generating, via execution of the machine learning model, one or more additional actions at a second time based on (i) a second state of the articulated object at a second time step and (ii) a second plurality of weights associated with the plurality of rewards; and computing a plurality of reward values for the plurality of rewards based on at least one of the first state, the one or more actions, or the second state; computing one or more losses based on the plurality of reward values and the first plurality of weights; and training the machine learning model based on the one or more losses.
21. In some embodiments, a computer-implemented method for controlling motion in an articulated object comprises generating, via execution of a machine learning model based on a first state of the articulated object at a first time step, a first plurality of weights for a plurality of rewards associated with the motion in the articulated object; determining (i) one or more actions associated with the motion of the articulated object at the first time step based on the first plurality of weights and (ii) a second state of the articulated object at a second time step based on the first state and the one or more actions; generating, via execution of the machine learning model based on the second state, a second plurality of weights for the plurality of rewards; determining one or more additional actions associated with the motion of the articulated object based on the second plurality of weights; and generating the motion based on the one or more actions and the one or more additional actions.
22. The computer-implemented method of clause 21, further comprising computing one or more additional rewards based on a prediction outputted by a discriminator model from the generated motion; and training the machine learning model based on the one or more additional rewards.
23. The computer-implemented method of any of clauses 21-22, further comprising training the discriminator model based on one or more losses associated with the prediction.
24. The computer-implemented method of any of clauses 21-23, wherein the one or more losses are generated based on (i) a first set of predictions outputted by the discriminator model based on a set of reference motions, (ii) a second set of predictions outputted by the discriminator model based on a set of motions generated via execution of the machine learning model, and (iii) a regularization term.
25. The computer-implemented method of any of clauses 21-24, further comprising receiving one or more user edits to the first plurality of weights prior to determining the one or more actions.
26. The computer-implemented method of any of clauses 21-25, wherein the one or more actions are generated by an additional machine learning model based on the first state and the first plurality of weights; and the one or more additional actions are generated by the additional machine learning model based on the second state and the second plurality of weights.
27. The computer-implemented method of any of clauses 21-26, wherein the motion is generated by a controller based on the one or more actions and the one or more additional actions.
28. The computer-implemented method of any of clauses 21-27, wherein the plurality of rewards comprises at least one of a tracking reward or a smoothness reward.
29. The computer-implemented method of any of clauses 21-28, wherein the machine learning model further generates the first plurality of weights based on (i) a motion reference at the first time step and (ii) a latent representation of a motion window that is centered at the first time step.
30. The computer-implemented method of any of clauses 21-29, wherein the motion reference comprises at least one of a root height, a root orientation, a root linear velocity, a root angular velocity, a joint angular position, a joint angular velocity, a hand pose, a foot pose, a hand linear velocity, or a foot linear velocity.
31. In some embodiments, one or more non-transitory computer-readable media store instructions that, when executed by one or more processors, cause the one or more processors to perform the steps of generating, via execution of a machine learning model based on a first state of an articulated object at a first time step, a first plurality of weights for a plurality of rewards associated with motion in an articulated object; generating, via execution of an additional machine learning model based on the first state and the first plurality of weights, one or more actions associated with a motion of the articulated object at the first time step; and causing a task associated with the articulated object to be performed based on the one or more actions.
32. The one or more non-transitory computer-readable media of clause 31, wherein the instructions further cause the one or more processors to perform the steps of determining a second state of the articulated object at a second time step based on the first state and the one or more actions; generating, via execution of the machine learning model based on the second state, a second plurality of weights for the plurality of rewards; generating, via execution of the additional machine learning model based on the second state and the second plurality of weights, one or more additional actions associated with the motion of the articulated object; and further causing the task to be performed based on the one or more additional actions.
33. The one or more non-transitory computer-readable media of any of clauses 31-32, wherein the task comprises generating the motion based on the one or more actions.
34. The one or more non-transitory computer-readable media of any of clauses 31-33, wherein the task comprises training the machine learning model based on one or more additional rewards associated with the one or more actions.
35. The one or more non-transitory computer-readable media of any of clauses 31-34, wherein the one or more additional rewards are computed based on a prediction generated by a discriminator model from a motion corresponding to the one or more actions.
36. The one or more non-transitory computer-readable media of any of clauses 31-35, wherein the first plurality of weights and the one or more actions are further generated based on (i) a motion reference at the first time step and (ii) a latent representation of a motion window that is centered at the first time step.
37. The one or more non-transitory computer-readable media of any of clauses 31-36, wherein the plurality of rewards is associated with at least one of a joint position, an end effector pose, a root orientation, a linear velocity, an angular velocity, or a smoothness.
38. The one or more non-transitory computer-readable media of any of clauses 31-37, wherein the machine learning model comprises a multi-layer perceptron.
39. The one or more non-transitory computer-readable media of any of clauses 31-38, wherein the articulated object comprises at least one of a legged robot or a physics-based character.
40. In some embodiments, a system comprises one or more memories that store instructions, and one or more processors that are coupled to the one or more memories and, when executing the instructions, are configured to perform the steps of generating, via execution of a machine learning model based on a first state of an articulated object at a first time step, a first plurality of weights for a plurality of rewards associated with motion in the articulated object; determining (i) one or more actions associated with a motion of the articulated object at the first time step based on the first plurality of weights and (ii) a second state of the articulated object at a second time step based on the first state and the one or more actions; generating, via execution of the machine learning model based on the second state, a second plurality of weights for the plurality of rewards; determining one or more additional actions associated with the motion of the articulated object based on the second plurality of weights; and training the machine learning model based on one or more additional rewards associated with the one or more actions and the one or more additional actions.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for controlling motion in an articulated object, the method comprising:
generating, via execution of a machine learning model based on a first state of the articulated object at a first time step, a first plurality of weights for a plurality of rewards associated with the motion in the articulated object;
determining (i) one or more actions associated with the motion of the articulated object at the first time step based on the first plurality of weights and (ii) a second state of the articulated object at a second time step based on the first state and the one or more actions;
generating, via execution of the machine learning model based on the second state, a second plurality of weights for the plurality of rewards;
determining one or more additional actions associated with the motion of the articulated object based on the second plurality of weights; and
generating the motion based on the one or more actions and the one or more additional actions.

2. The computer-implemented method of claim 1, further comprising:
computing one or more additional rewards based on a prediction outputted by a discriminator model from the generated motion; and
training the machine learning model based on the one or more additional rewards.

3. The computer-implemented method of claim 2, further comprising training the discriminator model based on one or more losses associated with the prediction.

4. The computer-implemented method of claim 3, wherein the one or more losses are generated based on (i) a first set of predictions outputted by the discriminator model based on a set of reference motions, (ii) a second set of predictions outputted by the discriminator model based on a set of motions generated via execution of the machine learning model, and (iii) a regularization term.

5. The computer-implemented method of claim 1, further comprising receiving one or more user edits to the first plurality of weights prior to determining the one or more actions.

6. The computer-implemented method of claim 1, wherein:
the one or more actions are generated by an additional machine learning model based on the first state and the first plurality of weights; and
the one or more additional actions are generated by the additional machine learning model based on the second state and the second plurality of weights.

7. The computer-implemented method of claim 1, wherein the motion is generated by a controller based on the one or more actions and the one or more additional actions.

8. The computer-implemented method of claim 1, wherein the plurality of rewards comprises at least one of a tracking reward or a smoothness reward.

9. The computer-implemented method of claim 1, wherein the machine learning model further generates the first plurality of weights based on (i) a motion reference at the first time step and (ii) a latent representation of a motion window that is centered at the first time step.

10. The computer-implemented method of claim 9, wherein the motion reference comprises at least one of a root height, a root orientation, a root linear velocity, a root angular velocity, a joint angular position, a joint angular velocity, a hand pose, a foot pose, a hand linear velocity, or a foot linear velocity.

11. One or more non-transitory computer-readable media storing instructions that, when executed by one or more processors, cause the one or more processors to perform the steps of:
generating, via execution of a machine learning model based on a first state of an articulated object at a first time step, a first plurality of weights for a plurality of rewards associated with motion in an articulated object;
generating, via execution of an additional machine learning model based on the first state and the first plurality of weights, one or more actions associated with a motion of the articulated object at the first time step; and
causing a task associated with the articulated object to be performed based on the one or more actions.

12. The one or more non-transitory computer-readable media of claim 11, wherein the instructions further cause the one or more processors to perform the steps of:
determining a second state of the articulated object at a second time step based on the first state and the one or more actions;
generating, via execution of the machine learning model based on the second state, a second plurality of weights for the plurality of rewards;
generating, via execution of the additional machine learning model based on the second state and the second plurality of weights, one or more additional actions associated with the motion of the articulated object; and
further causing the task to be performed based on the one or more additional actions.

13. The one or more non-transitory computer-readable media of claim 11, wherein the task comprises generating the motion based on the one or more actions.

14. The one or more non-transitory computer-readable media of claim 11, wherein the task comprises training the machine learning model based on one or more additional rewards associated with the one or more actions.

15. The one or more non-transitory computer-readable media of claim 14, wherein the one or more additional rewards are computed based on a prediction generated by a discriminator model from a motion corresponding to the one or more actions.

16. The one or more non-transitory computer-readable media of claim 11, wherein the first plurality of weights and the one or more actions are further generated based on (i) a motion reference at the first time step and (ii) a latent representation of a motion window that is centered at the first time step.

17. The one or more non-transitory computer-readable media of claim 11, wherein the plurality of rewards is associated with at least one of a joint position, an end effector pose, a root orientation, a linear velocity, an angular velocity, or a smoothness.

18. The one or more non-transitory computer-readable media of claim 11, wherein the machine learning model comprises a multi-layer perceptron.

19. The one or more non-transitory computer-readable media of claim 11, wherein the articulated object comprises at least one of a legged robot or a physics-based character.

20. A system, comprising:
one or more memories that store instructions, and
one or more processors that are coupled to the one or more memories and, when executing the instructions, are configured to perform the steps of:
generating, via execution of a machine learning model based on a first state of an articulated object at a first time step, a first plurality of weights for a plurality of rewards associated with motion in the articulated object;
determining (i) one or more actions associated with a motion of the articulated object at the first time step based on the first plurality of weights and (ii) a second state of the articulated object at a second time step based on the first state and the one or more actions;
generating, via execution of the machine learning model based on the second state, a second plurality of weights for the plurality of rewards;
determining one or more additional actions associated with the motion of the articulated object based on the second plurality of weights; and
training the machine learning model based on one or more additional rewards associated with the one or more actions and the one or more additional actions.
